(19) United States
(12) Patent Application Publication
(10) Pub. No.: US 2010/0327033 A1
(43) Pub. Date: Dec. 30, 2010

(54) ROOF RACK SYSTEM

(76) Inventor: William Turner Payne, Durban (ZA)

Correspondence Address: YOUNG & THOMPSON, 209 Madison Street, Suite 500, Alexandria, VA, 22314, US

(21) Appl. No.: 12/864,939

(22) PCT Filed: Dec. 19, 2008
(86) PCT No.: PCT/ZA08/00125

§ 371 Date: Jul. 28, 2010

(30) Foreign Application Priority Data
Dec. 21, 2007 (ZA) 2007/11200

(51) Int. Cl. B60R 9/04

(52) U.S. Cl. 224/326

(57) ABSTRACT

A roof rack system for a vehicle which has a fixed cab and a canopy which includes a pair of rails extending along the length of the vehicle and the canopy, and a number of transverse rails for supporting articles. The rails are fixed to the cab of the vehicle by a conventional element, but brackets are provided on the canopy for receiving both the longitudinal and the transverse rails. The brackets are height adjustable to account for differences between the height of the cab and the canopy of the vehicle, or to accommodate the system on various makes of vehicles which may have differing dimensions. The rails include aluminum or a similar material and are substantially oval on the upper part and flat on the lower parts (closed to the vehicle) when viewed in section.

### TECHNICAL FIELD OF THE INVENTION

This invention relates to a roof rack system for a vehicle having a detachable rear canopy and a fixed cab, for example a bakkie or LDV.

### BACKGROUND ART

Roof racks for bakkies, LDV's or the like SUV's which have a forward cab housing the driver and passenger and a usually detachable rear canopy covering the load box, are designed to be fixed to the canopy only. This is mainly due to the fact that different brackets are required to attach to the roof of the cab and the roof of the canopy. In addition, because the canopy is not integrally formed with the body of the vehicle, substantially movement of the canopy relative to the cab is likely to occur which may cause damage to the roof rack, the cab and the canopy. The lack of roof rack over the cab makes transportation of longer articles such as ladders, canoes, poles, piping and the like somewhat difficult. In the event that a method is found to secure these articles, the load is often unstable and can impair driving.

Furthermore, these systems typically comprise a pair of spaced apart transverse rails mounted atop the canopy on brackets. No longitudinal supports are provided between the rails which limits the types of cargo that maybe transported on the roof rack, and further impedes securing of cargo to the roof rack.

It is therefore an object of this invention to provide a roof rack system for use with vehicles having canopies which is securely attachable to both the canopy and the roof of the vehicle, and which is adapted to accommodate a degree of movement of the canopy relative to the vehicle cab. In particular, the applicant seeks to provide a bracket which makes such a system operable without the disadvantages of prior art systems.

### DISCLOSURE OF THE INVENTION

According to the invention, a roof rack system for use with a vehicle having a fixed cab and a canopy, comprises at least one pair of rails extending parallel to the longitudinal axis of the vehicle, and at least one pair of transverse rails extending therebetween, the rails being mounted atop the canopy of a vehicle by means of common brackets; and a further pair of transverse rails mounted atop the cab of the vehicle and having a pair of longitudinal rails extending therebetween, these rails also being mounted by means of brackets; each bracket including a channel formation for receiving and retaining a transverse rail, and a collar member for receiving a longitudinal rail in a firm frictional fit.

The rails and in particular, the transverse rails are preferably slightly bowed which improves strength and facilitate location of the brackets towards the lateral extremes of the roof. These locations are typically also arcuate in shape as opposed to a location closer to the midpoint of the roof which is substantially flat.

In the preferred form of the invention, the roof rack system includes two discrete sets of longitudinal rails which lie parallel and in register but are either slightly separated, or are joined in a manner which permits rotation thereof relative to each other about the longitudinal axes thereof. In this form two pairs of brackets each are provided for mounting on the cab and canopy respectively. Also in the preferred form of the invention, at least the brackets atop the canopy are height adjustable to account for variations in height between the canopy and the cab of the vehicle and also to allow for variations between different models of vehicles and canopies.

In the preferred form the brackets for mounting the system atop the vehicle roof are not height adjustable and attach to the gutter of the vehicle roof by means of a clamp system in the same manner as prior art systems. In an improvement over prior art systems, the bracket is provided with a pair of mounting elements locatable between the base thereof and the vehicle (cab) roof.

A first plastic mounting element is provided which includes a flat base with the upper surface decreasing in depth towards an off-centre line on which longitudinal knuckles are located at each end. The underside of the bracket includes a correspondingly shaped and dimensioned cavity for receiving the first mounting element therein. The cavity is identically shaped save for the fact that the upwardly sloping side sections are angled 12 degrees higher than the corresponding surfaces of the mounting element. The cavity includes lateral sockets for receiving the knuckles. The first mounting insert includes a central oval aperture for receiving a clamping bolt therethrough.

The second mounting element comprises a deformable rubber and includes a flat upper surface for engaging the underside of the first mounting element, the lower surface being sloped inwardly toward the centre of the roof, also at an angle of 12 degrees. This arrangement permits the bracket to be located towards the lateral extremes of the cab roof as described above, with the flexible second mounting element being able to take up angles of 12 degrees on the outer side and 24 degrees on the inner side.

The second mounting element has a depth dimension which prevents the bracket engaging the cab even when it is required to take up maximum curvature angles described above.

According to a second aspect of the invention, a bracket for mounting a roof rack system atop a vehicle having a fixed cab and a canopy, and which system includes both longitudinal and transverse rails, comprises a height adjustable, upright body portion mountable on the canopy; the upright body portion including a first formation for receiving and retaining a transverse rail of the roof rack, and a second retaining formation for receiving and retaining a longitudinal rail of the roof rack system.

In the preferred form of the invention, the first retaining formation comprises a channel formation including a fastener for retaining the end of the transverse rail within the channel, the second retaining formation comprising a collar for receiving the longitudinal rail therethrough in a slidable frictional engagement. The channel formation may be oval in section. The collar preferably includes an aperture for receiving a fastener which screws into the top of the rail to prevent its removal. Similarly, the channel formation also includes an aperture for receiving a fastener for securing the transverse rail. The collar is preferably also generally oval in section but is profiled to include an internal ridge for slidably engaging a correspondingly shaped and dimensioned cavity extending longitudinally along the side of the longitudinal rail.

The bracket must be height adjustable to account for any difference in height between the canopy and the roof of the cab of the vehicle. Accordingly the upright body portion may comprise a pair of rotatably interconnected telescoping members. In this form, a fixed upper member is provided which includes a centrally located screw-threaded, fixed shaft; and a lower member rotatable about the shaft, the shaft being of sufficient length to extend through an aperture formed in the roof of the canopy to which it is secured by means of a suitable nut; the height of the bracket being variable by the rotation of the lower telescoping member about the shaft. In one form of the invention, in which the bracket comprises metal, the shaft is mounted in a mounting plate spanning the diameter of the upper telescoping member and fixed to the member by means of welding or the like. Similarly the shaft is anchored to the mounting plate in a manner that prevents rotation of the shaft. The lower telescoping member may also include a mounting plate spanning its diameter and including a screw-threaded aperture for receiving the shaft therethrough.

In the preferred form of the invention, the bracket comprises injection moulded plastic and the upper telescoping member includes an insert including an hexagonal recess at the upper end thereof for receiving a nut therein, the shaft being secured in the upper telescoping member by inserting it through an aperture extending through the channel formation and tightening it against the nut in the insert. The channel formation may also comprise a cylindrical or oval collar for use with a cylindrical or oval transverse rail. The bolt preferably comprises a snap-off bolt, having a hexagonal head. Several snap-off points or liner of weakness are provided to permit use with different vehicles. A tube spanner having a correspondingly dimensioned hexagonal socket may be provided to tighten the bolt and then snap-off the head thereof.

A mounded bolt-cap may be provided to conceal the top of the snapped-off bolt. Further, the underside of the insert may include a raised section surrounding the aperture. A rubber seating element is provided between the insert and the canopy, the sealing element being deformable and including a circumferential lip for engaging the periphery of the insert when the bracket is fastened against the canopy.

In the preferred form, the inside wall of the collar is tapered from the centre to the openings thereof. This permits insertion of the rails at a slight angle or tilt to account for slightly angled cab or canopy roofs. The collar may further include one or more circumferential ridges inside its interior. This enables the collar to fit rails snugly even when there are slight variations in the diametrical consistency of the rails. The ridges are designed to shear off if the rail fit is tight.

When used on a standard-length vehicle, four transverse rails are typically required, two each on the canopy and the cab.

For longer wheel-base vehicles, an intermediate transverse rail may be required. Accordingly an additional bracket may be provided which does not engage the vehicle roof or canopy but simply engages the longitudinal rail. This bracket includes a vertically orientated oval collar for receiving the longitudinal rail therethrough, and an inwardly directed oval channel formation for receiving the transverse rail therein. The bracket slidably engages the rail in the same manner as the other brackets.

It has further been proposed by the applicant to provide a front transverse bar locatable between the front ends of the longitudinal rails. The bar preferably includes a plurality of spaced apart fins extruding parallel to the longitudinal rails. This bar may be described as a vortex disruption bar and functions to disrupt the passage of air flowing past the transverse rails. It was discovered by the applicant that in the absence of the vortex disruption bar, air flow between the transverse rails and the vehicle roof created a vortex of sufficient strength to cause the roof panel to vibrate and in so doing create an irritating noise. The introduction of the vortex disruption bar minimizes this noise. The bar is angled slightly downwardly to be approximately parallel to the vehicle windscreen.

In the preferred form of the invention, the transverse rails include a flat bottom side whilst the upper side is arcuate in cross-section. The rails comprises a hollow aluminium profile have flat underside and rounded ends when viewed in section. The rounded ends extend back towards each other and toward the centre of the rail, each forming a lip over a flat top side of the rail orientated parallel to the underside. The lips define a channel for slidable insertion of a moulded plastic section which has an arcuate upper surface and extends the length of the rail. Each rail is provided with an aperture near each end for receiving a fastener to secure the rail to the bracket.

### BRIEF DESCRIPTION OF THE DRAWINGS

The preferred embodiment of the invention is described below with reference to the accompanying drawings in which:

FIG. 1 is a perspective view from above of a vehicle roof rack system according to the invention;

FIG. 2 is a sectional side view through the height-adjustable bracket of FIG. 1;

FIG. 3 is a sectional end view through a height-adjustable bracket for mounting the system atop the canopy of the vehicle;

FIG. 4 is a sectional side view through a bracket for mounting the system on the vehicle roof;

FIG. 5 is a sectional end view of FIG. 4;

FIG. 6 is a sectional view through a longitudinal rail;

FIG. 7a and b are sectional views through a transverse rail;

FIG. 8 is a sectional view through a vortex disruption bar;

FIG. 9 is a sectional side view through an intermediate bracket for use on longer vehicles; and

FIG. 10a and b are side views of a snap-off bolt and tube spanner for use therewith.

### BEST MODE FOR CARRYING OUT THE INVENTION

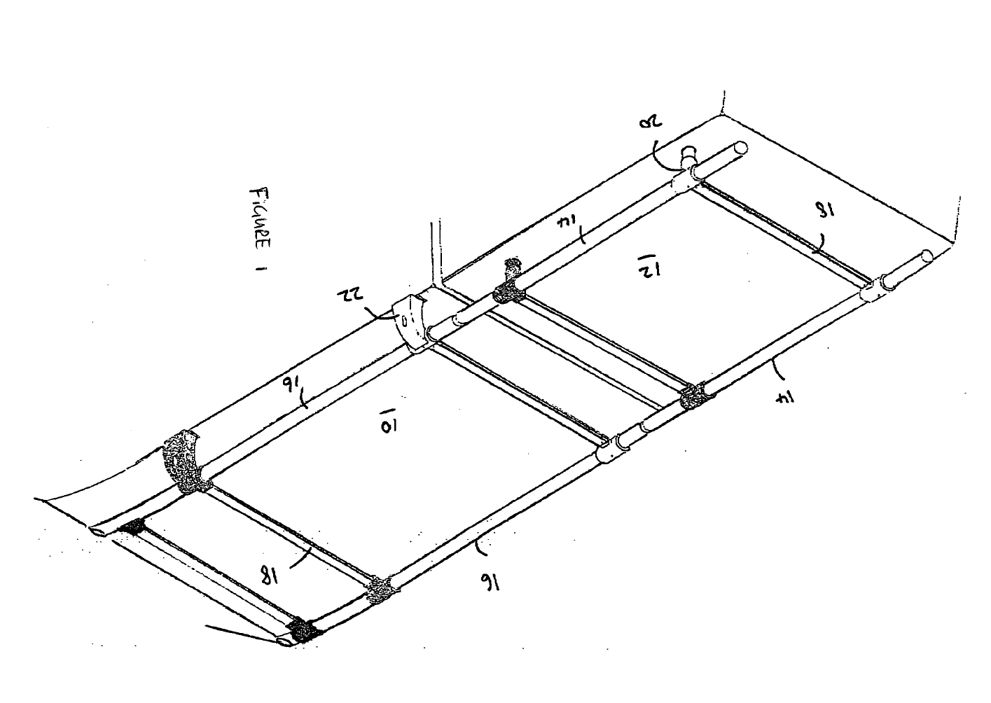

In FIG. 1 a roof rack system for spanning a vehicle cab 10 and canopy 12 comprises two pairs of longitudinal rails 14,16 and four transverse rails 18, mounted on the canopy by means of height-adjustable brackets 20 and atop the cab by means of fixed brackets 22.

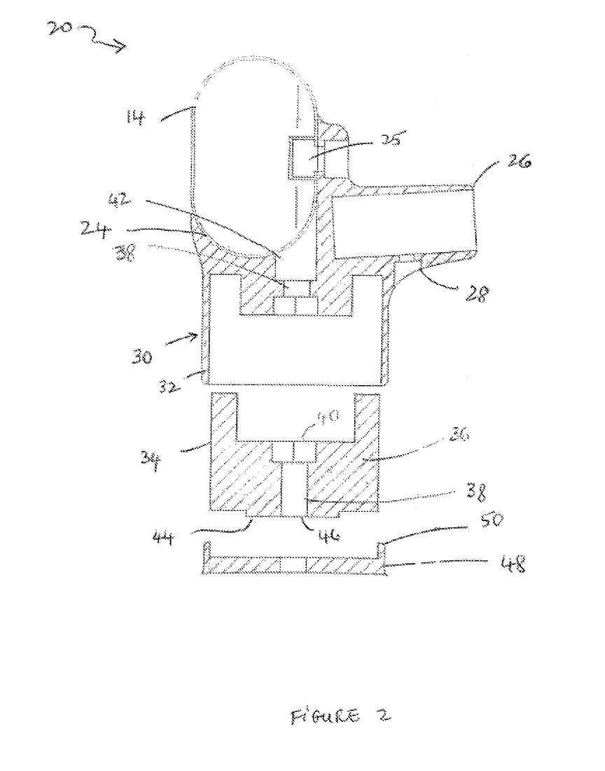

A unique feature of the invention is the provision of the longitudinal rails and the common mounting bracket for both the transverse and longitudinal rails. This is achieved by the brackets including a collar portion 24 for receiving the oval longitudinal rails in a sliding frictional fit and a channel portion 26 having screws or the like fasteners (not shown) for fixing the bowed or arcuate transverse rails in the channels, through apertures 28. This is illustrated clearly in FIGS. 2 through 5 which show the height-adjustable bracket 20 and fixed bracket 22 respectively.

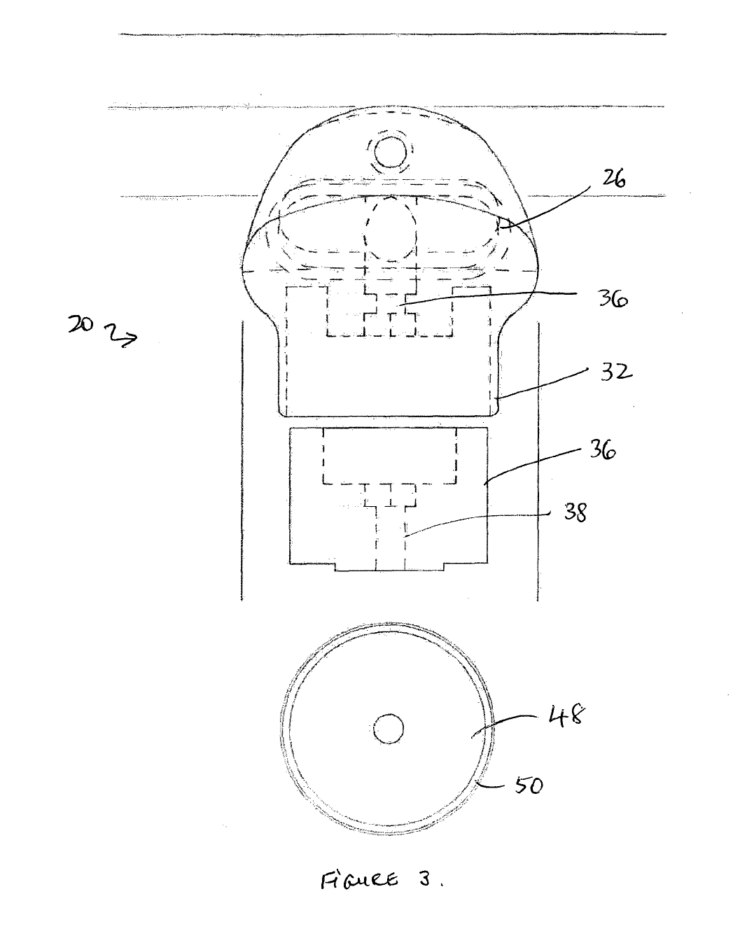

In FIGS. 2 and 3, plastic height-adjustable brackets 20 are shown to include an upright body portion 30 comprising telescoping members 32 and 34. Upper member 32 is integral with the collar 24 and channel 26, and includes an insert 36 fitting snugly into its internal diameter. A screw-threaded shaft 38 about which lower telescoping member 34 is rotatable, is provided. The lower member 34 is secured to the body portion 30 by means of a nut which is located in a hexagonal recess 40 in the top of the insert 36. Tightening of the shaft through aperture 42 and the nut secures the shaft to the body portion. Rotation of the lower member 34 causes the telescoping action and height adjustability. The shaft 38 extends through a hole formed in the roof of the canopy and is secured to the canopy by means of a nut (not shown). The insert 36 includes a raised section 44 about the aperture 46 which engages flexible rubber sealing member 48 which includes a circumferential lip 50 to seal about the periphery of insert 36 when the bracket is fastened to the canopy.

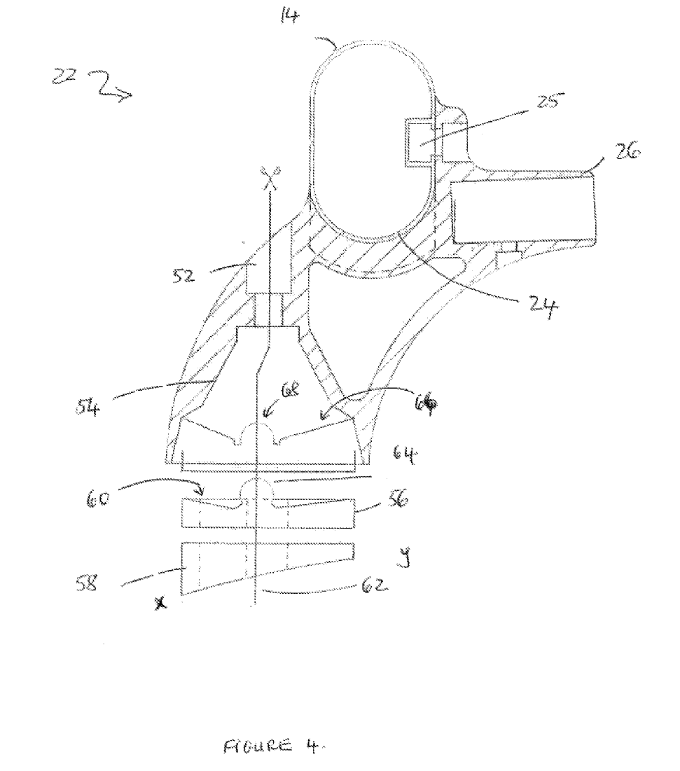

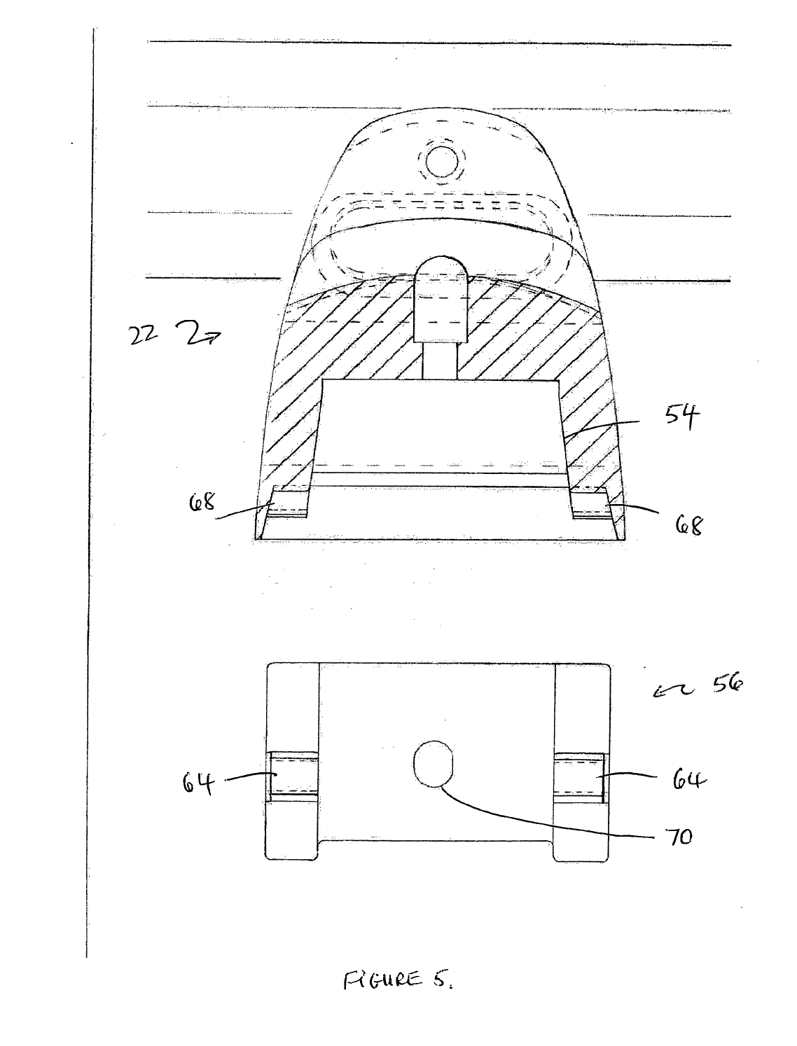

In FIGS. 4 and 5, an example of a fixed bracket 22 is shown. This bracket is not height-adjustable and is clamped to the gutter of the vehicle cab by means of a clamp well known in the prior art. The clamp is secured to the bracket by means of a bolt.

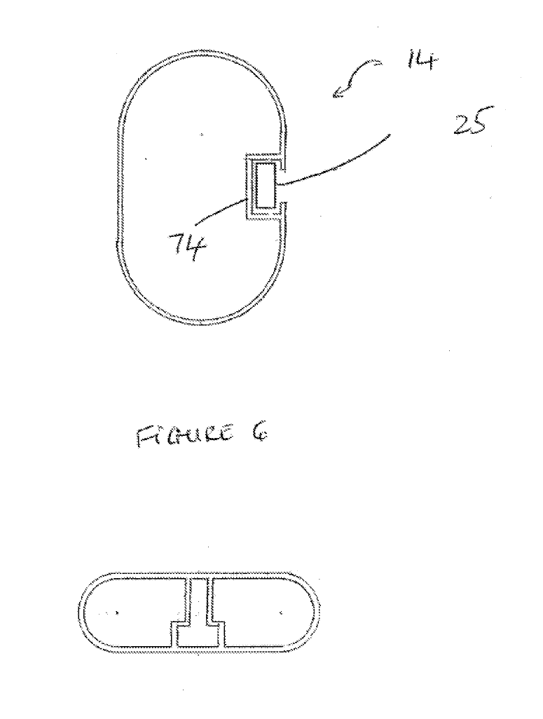

As in the height-adjustable bracket 20, the fixed bracket 22 includes a collar 24 for receiving a longitudinal rail 14 which is oval in the embodiment shown. The rail slidably engages the collar which includes a track 25 for engaging a correspondingly shaped recess 74 as shown in FIG. 6.

The bracket 22 is not height-adjustable, but is designed to permit mounting on the curved section of the vehicle roof. This section of the roof is stronger than the flatter zones closer to the middle of the roof. A snap-off bolt (see FIG. 10a), is used to secure the bracket to the roof and extends through aperture 52, cavity 54, and dual mounting elements 56 and 58.

Plastic mounting element 56 has a flat base but an upper surface 60 which slopes inwardly and downwardly towards an off-centre line 62. Knuckles 64 are located at either end of this mounting element 56.

The underside of the bracket 22 includes a correspondingly shaped and dimensioned cavity 54 for receiving mounting element 56 therein.

The cavity is identically shaped except that the upwardly sloping sections 66 are angled twelve degrees higher than the corresponding surfaces 60 of the mounting element 56. Lateral sockets 68 are provided for receiving the knuckles 64. A central oval aperture 70 is provided to receive the clamping bolt (FIG. 10a) therethrough.

The second mounting element 58 comprises deformable rubber and is approximately wedge-shaped in section. A flat upper surface engages the underside of element 56 while the lower surface 72 slopes inwardly toward the centre of the vehicle roof at an angle of twelve degrees. This design permits location of the bracket at the curved lateral extremes of the vehicle roof. The flexible rubber mounting element 58 can “take-up” twenty four degrees at its outer end x and twelve degrees at its inner end y.

Turning now to FIG. 6, longitudinal rails 14 is shown to comprise an oval profile including a recess 74 at its vertical midpoint on one side, for slidably engaging track 25 on the brackets 20 and 22.

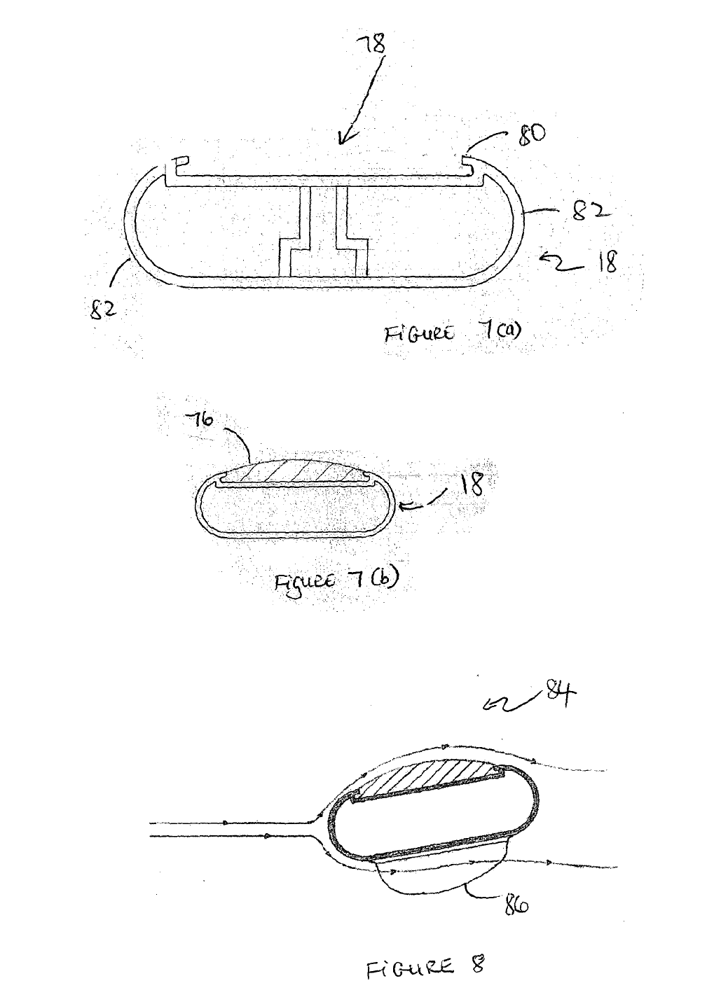

FIGS. 7(a) and (b) show cross sections through an oval transverse rail 18, with the rail in 7(b) shown to include an arcuate plastic insert 76. The insert slides into a channel 78 defined by lips 80 formed by inward extensions of the rounded ends 82 of the rail.

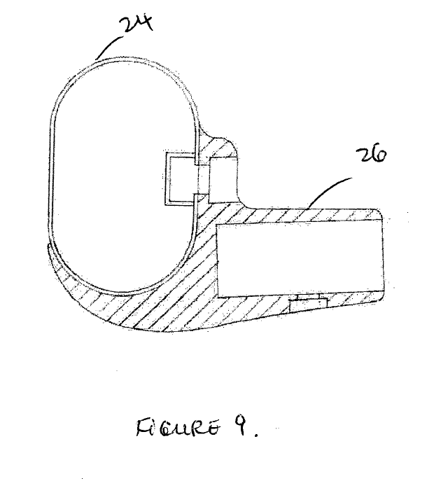

In order to reduce vibration of the vehicle roof panel caused by the flow of air between the roof panel and the transverse rails, a vortex disruption bar 84 (FIG. 8) is provided as an additional transverse rail at the font of the roof rack system. The bar comprises a typical transverse rail mounted at an angle to the roof (but parallel to the vehicle windscreen) and including several spaced apart fins 86 which serve to disrupt linear air flow. This has the effect of reducing any vortex formation between the roof and transverse rails and accordingly eliminates vibration of the roof panel and the noise associated therewith.

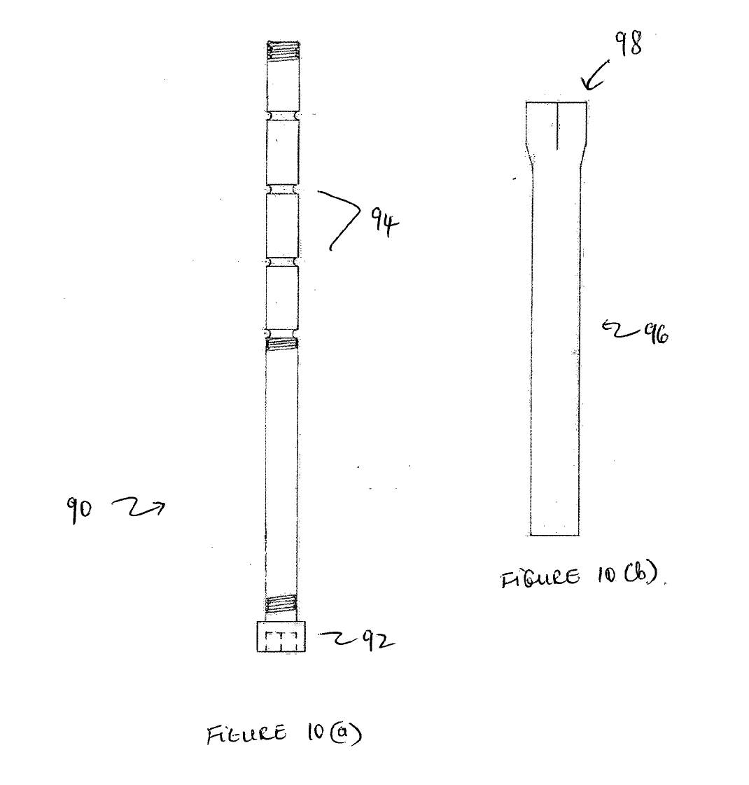

Longer wheel-base vehicles may require an intermediate bracket 88 as shown in FIG. 9 to permit fitment of an additional transverse rail. This bracket 88 does not engage the canopy but simply serves to secure the additional transverse rail to the longitudinal rail. The same collar 24 and channel 26 formations are provided as for brackets 20 and 22.

In FIG. 10(a) a snap-off bolt 90 having a hexagonal head 92 which may be used to secure the brackets 20 and 22 to the canopy and vehicle roof respectively. Several lines of weakness 94 are provided. Tube spanner (96 in FIG. 10(b) has a hexagonal socket 98 for tightening the bolt and snapping-off the head.

1-43. (canceled)

44. A roof rack system for use with a vehicle having a fixed cab and a canopy characterized in that it comprises at least one pair of rails extending parallel to the longitudinal axis of the vehicle, and at least one pair of transverse rails extending therebetween, the rails being mounted atop the canopy of a vehicle by means of common brackets; and a further pair of transverse rails mounted atop the cab of the vehicle and having a pair of longitudinal rails extending therebetween, these rails also being mounted by means of brackets; each bracket including a channel formation for receiving and retaining a transverse rail, and a collar member for receiving a longitudinal rail in a firm frictional fit.

45. A roof rack system for use with a vehicle having a fixed cab and a canopy according to claim 44 characterized in that the rails and in particular, the transverse rails are slightly bowed.

46. A roof rack system for use with a vehicle having a fixed cab and a canopy according to claim 45 characterized in that the system includes two discrete sets of longitudinal rails which lie parallel and in register but are either slightly separated, or are joined in a manner which permits rotation thereof relative to each other about the longitudinal axes thereof.

47. A roof rack system for use with a vehicle having a fixed cab and a canopy according to claim 44 characterized in that at least the brackets atop the canopy are height adjustable.

48. A roof rack system for use with a vehicle having a fixed cab and a canopy according to claim 44 characterized in that each bracket for mounting atop the vehicle cab is provided with first and second mounting elements locatable between the base thereof and the vehicle (cab) roof, the first mounting element including a flat base with the upper surface decreasing in depth towards an off-centre line on which longitudinal knuckles are located at each end; the second mounting element comprising a deformable rubber and including a flat upper surface for engaging the underside of the first mounting element, the lower surface being sloped inwardly toward the centre of the roof, at an angle of 12 degrees.

49. A roof rack system for use with a vehicle having a fixed cab and a canopy according to claim 48 characterized in that the underside of the bracket includes a correspondingly shaped and dimensioned cavity for receiving the first mounting element therein, the cavity being identically shaped to the first mounting element save for the fact that the upwardly sloping side sections are angled 12 degrees higher than the corresponding surfaces of the mounting element.

50. A roof rack system for use with a vehicle having a fixed cab and a canopy according to claim 49 characterized in that the cavity includes lateral sockets for receiving the knuckles and the first mounting element includes a central oval aperture for receiving a clamping bolt therethrough.

51. A roof rack system for use with a vehicle having a fixed cab and a canopy according to claim 48 characterized in that the second mounting element has a depth dimension which prevents the bracket engaging the cab even when it is required to take up maximum curvature angles described above.

52. A roof rack system according to claim 44 characterized in that the collar is oval in section and is profiled to include an internal ridge for slidably engaging a correspondingly shaped and dimensioned cavity extending longitudinally along the side of the longitudinal rail.

53. A roof rack system according to claim 47 characterized in that the bracket is height adjustable and includes an upright body portion comprising a pair of rotatably interconnected telescoping members.

54. A roof rack system according to claim 53 characterized in that the rotatably interconnected telescoping members comprise a fixed upper member including a centrally located screw-threaded, fixed shaft; and a lower member rotatable about the shaft, the shaft being of sufficient length to extend through an aperture formed in the roof of the canopy to which it is secured by means of a suitable nut; the height of the bracket being variable by the rotation of the lower telescoping member about the shaft.

55. A roof rack system according to claim 54 characterized in that when the bracket comprises metal, the shaft is mounted in a mounting plate spanning the diameter of the upper telescoping member and fixed to the member by means of welding or the like; and the shaft is anchored to the mounting plate in a manner that prevents rotation of the shaft.

56. A roof rack system according to claim 55 characterized in that the lower telescoping member includes a mounting plate spanning its diameter and including a screw-threaded aperture for receiving the shaft therethrough.

57. A roof rack system according to claim 55 characterized in that the bracket comprises injection moulded plastic and the upper telescoping member includes an insert including an hexagonal recess at the upper end thereof for receiving a nut therein, the shaft being secured in the upper telescoping member by inserting it through an aperture extending through the channel formation and tightening it against the nut in the insert.

58. A roof rack system according to claim 44 characterized in that, for longer wheel-base vehicles, one or more intermediate transverse rails are required, the intermediate rails being attached by means of an additional bracket which does not engage the vehicle roof or canopy but simply engages the longitudinal rail.

59. A roof rack system according to claim 44 characterized in that a front transverse bar is provided locatable between the front ends of the longitudinal rails.

60. A roof rack system according to claim 59 characterized in that the bar includes a plurality of spaced apart fins extruding parallel to the longitudinal rail which function to disrupt the passage of air flowing past the transverse rails.

61. A roof rack system according to claim 44 characterized in that the transverse rails include a flat bottom side whilst the upper side is arcuate in cross-section.

62. A roof rack system according to claim 61 characterized in that the rails comprise a hollow aluminium profile having flat undersides and rounded ends when viewed in section.

63. A roof rack system according to claim 62 characterized in that the rounded ends extend back towards each other and toward the centre of the rail, each forming a lip over a flat top side of the rail orientated parallel to the underside and the lips define a channel for slidable insertion of a moulded plastic section which has an arcuate upper surface and extends the length of the rail.
